(19) United States
(12) Patent Application Publication
(10) Pub. No.: US 2015/0089431 A1
(43) Pub. Date: Mar. 26, 2015

(54) METHOD AND TERMINAL FOR DISPLAYING VIRTUAL KEYBOARD AND STORAGE MEDIUM

(71) Applicant: Xiaomi Inc., Beijing (CN)

(72) Inventors: Dongfang Ji, Beijing (CN); Daokuan Liu, Beijing (CN); Xinyan Xing, Beijing (CN)

(73) Assignee: Xiaomi Inc.

(21) Appl. No.: 14/471,936

(22) Filed: Aug. 28, 2014

Related U.S. Application Data
(63) Continuation of application No. PCT/CN2014/077112, filed on May 9, 2014.

(30) Foreign Application Priority Data
Sep. 24, 2013 (CN) 201310438148.9

(51) Int. Cl. G06F 3/0488; G06F 3/0482

(52) U.S. Cl. CPC G06F 3/04886; G06F 3/0482
USPC 715/773

(57) ABSTRACT

The present disclosure provides a method, a device, and a terminal for displaying a virtual keyboard. The method includes: receiving a preset triggering signal for triggering display of the virtual keyboard; determining a display region according to a triggering location of the preset triggering signal; and displaying the virtual keyboard in the display region.

### CROSS-REFERENCE TO RELATED APPLICATIONS

The present application is a continuation of International Application No. PCT/CN2014/077112, filed May 9, 2014, which claims priority from Chinese Patent Application No. 201310438148.9, filed Sep. 24, 2013, the entire content of all of which are incorporated herein by reference.

### TECHNICAL FIELD

The present disclosure generally relates to the field of electronic device and, more particularly, to a method and a terminal for displaying a virtual keyboard.

### BACKGROUND

A keyboard is a device for inputting information, and is continuously improved as digital products are upgraded. Following the emergence of touchscreen technology, virtual keyboards based on touchscreens start to appear. Unlike a physical keyboard, user input operations directly applied to a screen are more efficient, convenient, and conforming to the logic of human-computer interaction. The touchscreen technology is considered as a key technology in mobile phone industry in the future.

A touch pen or a finger may be used to operate a touchscreen. Delicate operations of touchscreens may be realized when using a touch pen, but using a touch pen requires more operation time comparing to using a finger. Therefore, more users tend to use their fingers to control the touchscreens. Generally, a virtual keyboard is displayed and fixed in a lower portion of a touchscreen on a terminal where a user may input information through the virtual keyboard.

There are several problems in the related art, for example, due to limited range of finger movements, a user has to move his/her fingers back and forth to touch the virtual keyboard that is fixed in the lower portion of a touchscreen. The back and forth movement of fingers is not convenient, and lowers input efficiency.

### SUMMARY

According to a first aspect of the present disclosure, there is provided a method for displaying a virtual keyboard, comprising: receiving a preset triggering signal for triggering display of the virtual keyboard; determining a display region according to a triggering location of the preset triggering signal; and displaying the virtual keyboard in the display region.

According to a second aspect of the present disclosure, there is provided a device for displaying a virtual keyboard, comprising: a processor; and a memory for storing instructions executable by the processor; wherein the processor is configured to: receive a preset triggering signal for triggering display of the virtual keyboard; determine a display region according to a triggering location of the preset triggering signal; and display the virtual keyboard in the display region.

According to a third aspect of the present disclosure, there is provided a non-transitory computer-readable medium that stores a set of instructions which, when executed by a processor, performs a method for displaying a virtual keyboard, the method comprising: receiving a preset triggering signal for triggering display of the virtual keyboard; determining a display region according to a triggering location of the preset triggering signal; and displaying the virtual keyboard in the display region.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain, rather than limit, the principles of the present disclosure.

FIG. 1 is a flowchart of a method for displaying a virtual keyboard on a terminal, according to an exemplary embodiment.

FIG. 2A is a flowchart of a method for displaying a virtual keyboard on a terminal, according to an exemplary embodiment.

FIG. 2B is a flowchart of a method for displaying a virtual keyboard on a terminal, according to an exemplary embodiment.

FIG. 2C is a schematic diagram of a virtual keyboard on a terminal, according to an exemplary embodiment.

FIG. 2D is a flowchart of a method for displaying a virtual keyboard on a terminal, according to an exemplary embodiment.

FIG. 2E is a schematic diagram of a virtual keyboard, according to an exemplary embodiment.

FIG. 2F is a schematic diagram of an arrangement of buttons of a virtual keyboard, according to an exemplary embodiment.

FIG. 2G is a schematic diagram of an arrangement of buttons of a virtual keyboard, according to an exemplary embodiment.

FIG. 2H is a schematic diagram for illustrating a movement of a virtual keyboard, according to an exemplary embodiment.

FIG. 3A is a flowchart of a method for displaying a virtual keyboard, according to an exemplary embodiment.

FIG. 3B is a schematic diagram of a virtual keyboard, according to an exemplary embodiment.

FIG. 4A is a flowchart of a method for displaying a virtual keyboard, according to an exemplary embodiment.

FIG. 4B a schematic diagram for determining a display region, according to an exemplary embodiment.

FIG. 5A is a flowchart of a method for displaying a virtual keyboard, according to an exemplary embodiment.

FIG. 5B a schematic diagram for determining a display region, according to an exemplary embodiment.

FIG. 6 is a block diagram of a device for displaying a virtual keyboard, according to an exemplary embodiment.

FIG. 7 is a block diagram of a device for displaying a virtual keyboard, according to an exemplary embodiment.

FIG. 8 is a block diagram of a terminal, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The term “terminal” used in this disclosure means general electronic equipment that includes a touchscreen. A terminal may be, for example, a smart mobile phone, a table PC, a smart television, an eBook reader, a Moving Picture Experts Group Audio Layer III (MP3) player, a Moving Picture Experts Group Audio Layer IV (MP4) player, a portable computer, a desktop computer, and the like.

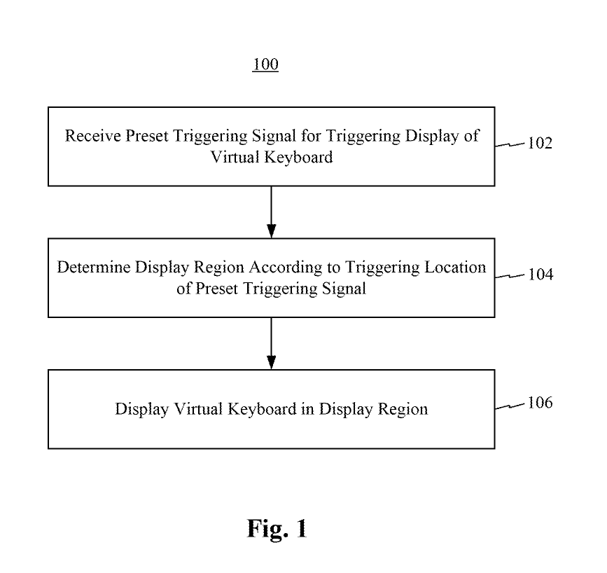

FIG. 1 is a flowchart of a method 100 for displaying a virtual keyboard on a terminal, according to an exemplary embodiment. Referring to FIG. 1, the method 100 comprises the following steps. In step 102, the terminal receives a preset triggering signal for triggering a virtual keyboard. In step 104, the terminal determines a display region for displaying a virtual keyboard, according to a triggering location of the preset triggering signal. In step 106, the terminal displays the virtual keyboard in the display region.

By using the method 100 for displaying a virtual keyboard in the above exemplary embodiment, the virtual keyboard can be displayed in the display region on the touchscreen determined by the triggering signal, and the fingers may directly touch the virtual keyboard in the display region. The method 100 solves the problem of low input efficiency caused by users having to move fingers for operating virtual keyboards displayed and fixed in the lower portion of the touchscreens and by a limited finger movement range. The method 100 reduces back-and-forth finger movements and improves efficiency of information input.

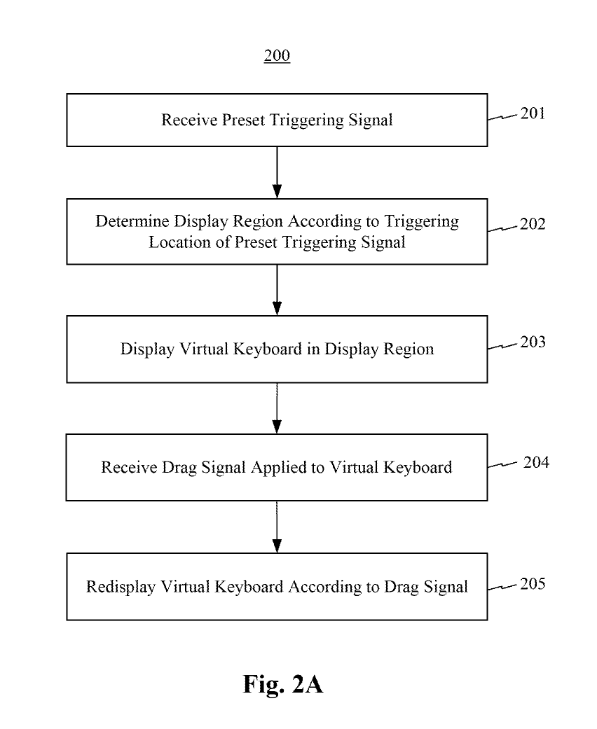

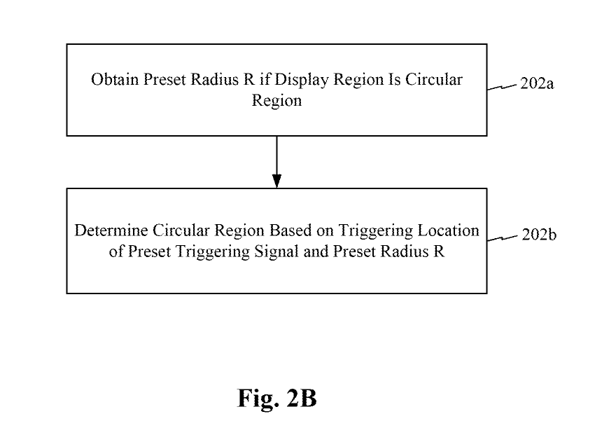

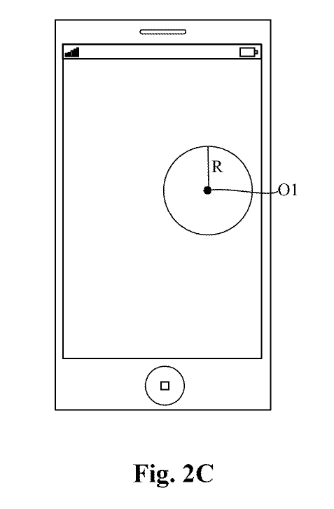

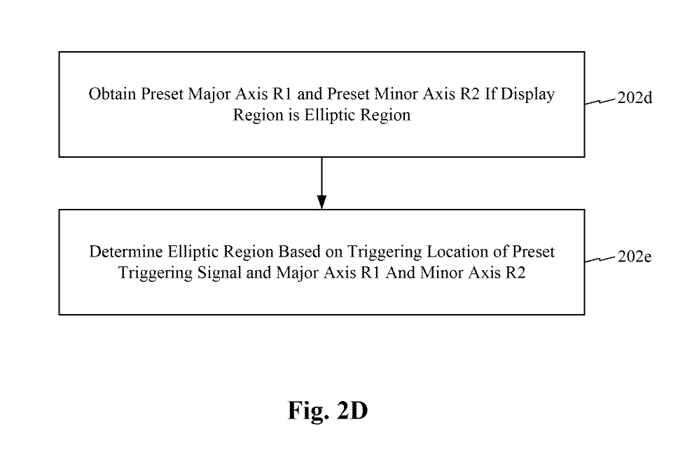

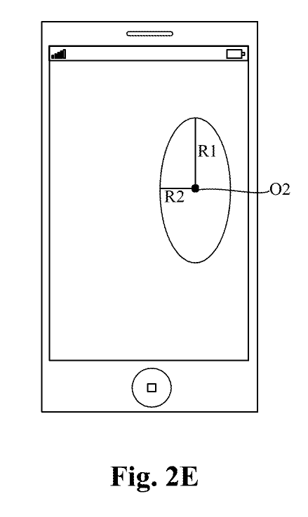

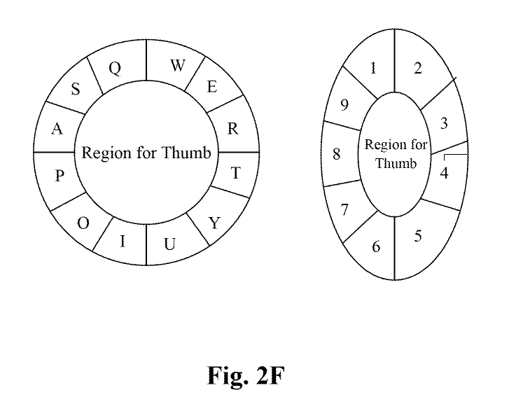

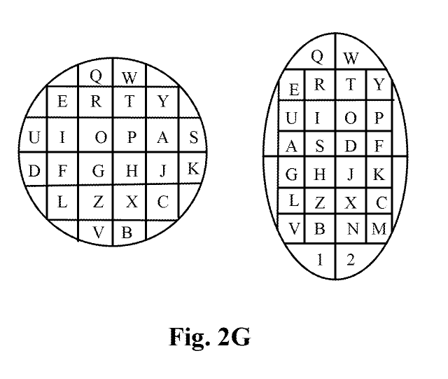

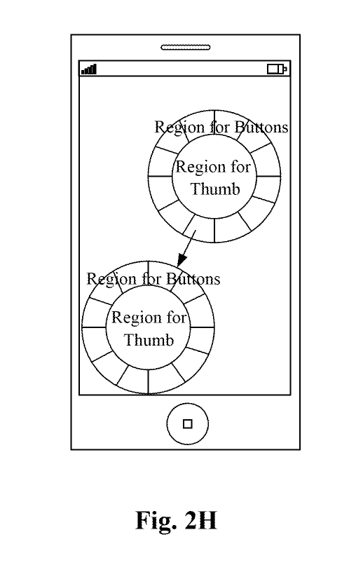

FIG. 2A is a flowchart of a method 200 for displaying a virtual keyboard on a terminal, according to an exemplary embodiment. The method 200 comprises the following steps. In step 201, the terminal receives a preset triggering signal that is triggered by a user. The preset triggering signal is used to trigger display of the virtual keyboard. The preset triggering signal may be triggered by clicking on an input box in an input interface with a finger, and may also be triggered by a long press on an unlock interface with a finger.

If the preset triggering signal is triggered by a click of a finger, a location on which the finger clicks is a triggering location of the preset triggering signal. If the preset triggering signal is triggered by a long press of a finger, a location on which the finger presses is a triggering location of the preset triggering signal. The preset triggering signal can be triggered by other methods, and is not limited by the above examples.

In step 202, the terminal determines a display region according to the triggering location of the preset triggering signal. The terminal displays the display region according to the triggering location of the preset triggering signal, wherein the display region may be a circular region or an elliptic region.

When the display region is a circular region, step 202 includes sub-steps 202a and 202b, as shown in FIG. 2B. In step 202a, when the display region is a circular region, a preset radius R of the circular region is obtained. It should be noted that the shape of the display region is preset by the terminal and may have any shape other than the circular shape. In step 202b, the circular region is determined based on the triggering location of the preset triggering signal as the center of the circular region, and the preset radius R. The above exemplary embodiment is illustrated in FIG. 2C, wherein the center of the circular region is formed at the triggering location 01, and the radius of the circular region is R.

When the display is an elliptic region, step 202 includes sub-steps 202d and 202e, as shown in FIG. 2D. In sub-step 202d, when the display region is an elliptic region, a preset major axis R1 and a preset minor axis R2 is obtained. It should be noted that the shape of the display region is preset by the terminal, and the shape of the display may have any shape other than the elliptic shape. In sub-step 202e, the elliptic region is determined based on the triggering location of the preset triggering signal as the center of the elliptic region, and the elliptic region is determined based on the major axis R1 and the minor axis R2. The above exemplary embodiment is illustrated in FIG. 2E, wherein the center of the elliptic region is formed at the triggering location O2, and the major axis and minor axis of the elliptic region are R1 and R2, respectively.

In step 203, the terminal displays the virtual keyboard in the display region. The terminal displays the virtual keyboard in the display region in a preset arrangement including, but not limited to, the following exemplary arrangements: 1) buttons of the virtual keyboard are uniformly arranged in a ring pattern in the display region, as illustrated in FIG. 2F; and 2) buttons of the virtual keyboard are uniformly arranged in a tile pattern in the display region, as illustrated in FIG. 2G

In step 204, the terminal receives a drag signal applied to the virtual keyboard. Referring to FIG. 2H, for example, the user may apply the drag signal to the virtual keyboard to move the virtual keyboard to a desired location, when the current/original location of the virtual keyboard does not meet the user's needs. In step 205, the virtual keyboard is redisplayed according to the drag signal as shown in FIG. 2H as an example.

By using the method 200 for displaying a virtual keyboard in the above exemplary embodiment, the virtual keyboard can be displayed in the display region on the touchscreen determined by the triggering signal, and the fingers may directly touch the virtual keyboard in display region. The method 200 solves the problem of low input efficiency caused by users having to move fingers for operating virtual keyboards displayed and fixed in the lower portion of the touchscreens and by a limited finger movement range. The method 200 reduces back-and-forth finger movements and improves efficiency of information input.

It should be noted that a user may customize the shape of the virtual keyboard when needed by setting the display region to be a circular shape, elliptic shape, or other shapes. The buttons of the virtual keyboard can be displayed in the display region determined by the user. Additionally, a user may adjust the display location of the virtual keyboard at any time by applying a drag signal to the virtual keyboard to redisplay the virtual keyboard according to the drag signal. Moreover, the terminal may be operated with one hand according to the above method.

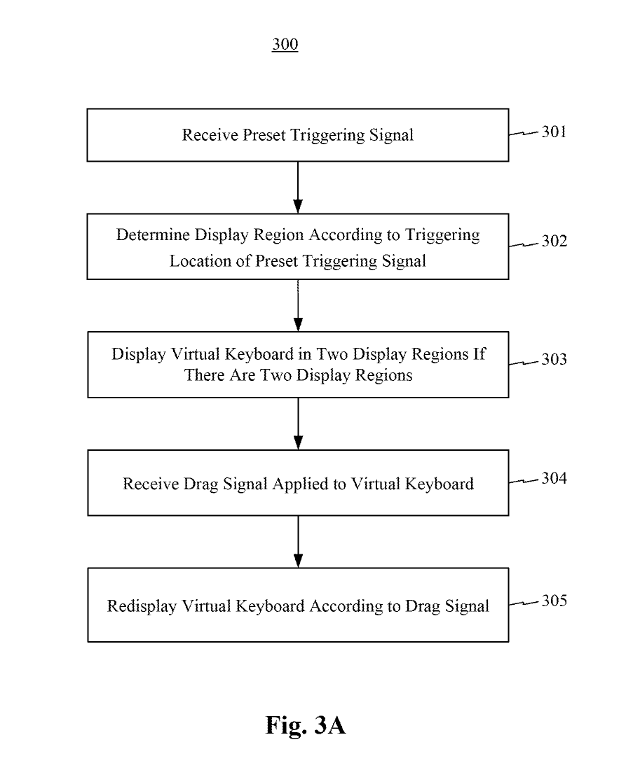

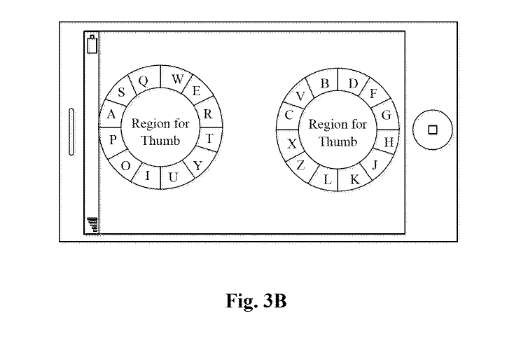

FIG. 3A is a flowchart of a method 300 for displaying a virtual keyboard on a terminal, according to an exemplary embodiment. The method 300 comprises the following steps. In step 301, the terminal receives a preset triggering signal triggered by a user. The triggering signal is used to trigger display of the virtual keyboard. The preset triggering signal may be triggered by clicking on an input box in an input interface with a finger, and may also be triggered by a long press on an unlock interface with a finger.

If the preset triggering signal is triggered by a click of a finger, a location on which the finger clicks is a triggering location of the preset triggering signal. If the preset triggering signal is triggered by a long press of a finger, a location on which the finger presses is the triggering location of the preset triggering signal. The preset triggering signal can be triggered by other methods, and is not limited by the above examples. For example, the terminal may receive two preset triggering signals that are triggered by a long press on touchscreen simultaneously with two fingers.

In step 302, the terminal determines a display region according to the triggering location of the preset triggering signal. The shape of the display region may be a circular shape, an elliptic shape, and other irregular shapes.

When the display region is a circular region, step 302 includes the following sub-steps: 1) When the display region is a circular region, a preset radius R is obtained for the circular region; and 2) the circular region is determined based on the triggering location of the preset triggering signal as the center of the circular region, and the preset radius R.

When the display region is an elliptic region, step 302 includes the following sub-steps: 1) a preset major axis R1 and a preset minor axis R2 is obtained; and 2) the elliptic region is determined based on the triggering location of the preset triggering signal as the center of the elliptic region, and the major axis R1 and the minor axis R2.

The manners of determining the circular display region and the elliptic display region in step 302 are similar to those shown in FIG. 2A. It should be noted that, in step 302, multiple, such as two, display regions are determined according to the triggering locations of the preset triggering signals, where the two display regions may be the same or different, because there are two preset triggering signals in this exemplary embodiment. The exemplary embodiment will be described in the following example that includes two display regions that are the same.

In step 303, the terminal displays the virtual keyboard in two display regions, for example, a first display region and a second display region. The terminal displays the virtual keyboard in two display regions such that a part of the virtual keyboard is displayed in the first display region in a preset manner and the other part of the virtual keyboard is displayed in the second display region in a preset manner. Not all buttons of the virtual keyboard are displayed in one of the two display regions. Referring to FIG. 3B, a portion of the buttons are displayed on the first display region on the left side, and the other portion of the buttons are displayed on the second display region on the right side, thereby facilitating controls of the virtual keyboard using left and right hands. The first and second display regions of the virtual keyboard may have the same shape, for example, as shown in FIG. 3B, or different shapes (not shown).

The terminal displays the virtual keyboard in the display region in a preset arrangement including, but not limited to, the following two exemplary arrangements: 1) buttons of the virtual keyboard are uniformly arranged in the display region in a ring pattern; and 2) buttons of the virtual keyboard are uniformly arranged in the display region in a tile pattern.

In step 304, the terminal receives a drag signal applied to the virtual keyboard. The user may apply a drag signal to the virtual keyboard to move the virtual keyboard to a desired location if the current/original location of the virtual does not meet user's needs. In step 305, the virtual keyboard is redisplayed according to the drag signal.

By using the method 300 for displaying a virtual keyboard in the above exemplary embodiment, the virtual keyboard can be displayed in the display region on the touchscreen determined by the triggering signal, and the fingers may directly touch the virtual keyboard in display region. The method 300 solves the problem of low input efficiency caused by users having to move fingers for operating virtual keyboards displayed and fixed in the lower portion of the touchscreens and by a limited finger movement range. The method reduces back-and-forth finger movements and improves efficiency of information input. Additionally, the user may adjust the display location of the virtual keyboard at any time when needed by applying the drag signal to the virtual keyboard to redisplay the virtual keyboard according to the drag signal.

It should be noted that when a user holds the electronic equipment horizontally, the user's left and right hands may operate concurrently if the virtual keyboard is displayed in e.g., two parts as being on the left and right sides of the electronic equipment, thereby improving the speed of information input. Moreover, the terminal may be operated with one hand according to the above method.

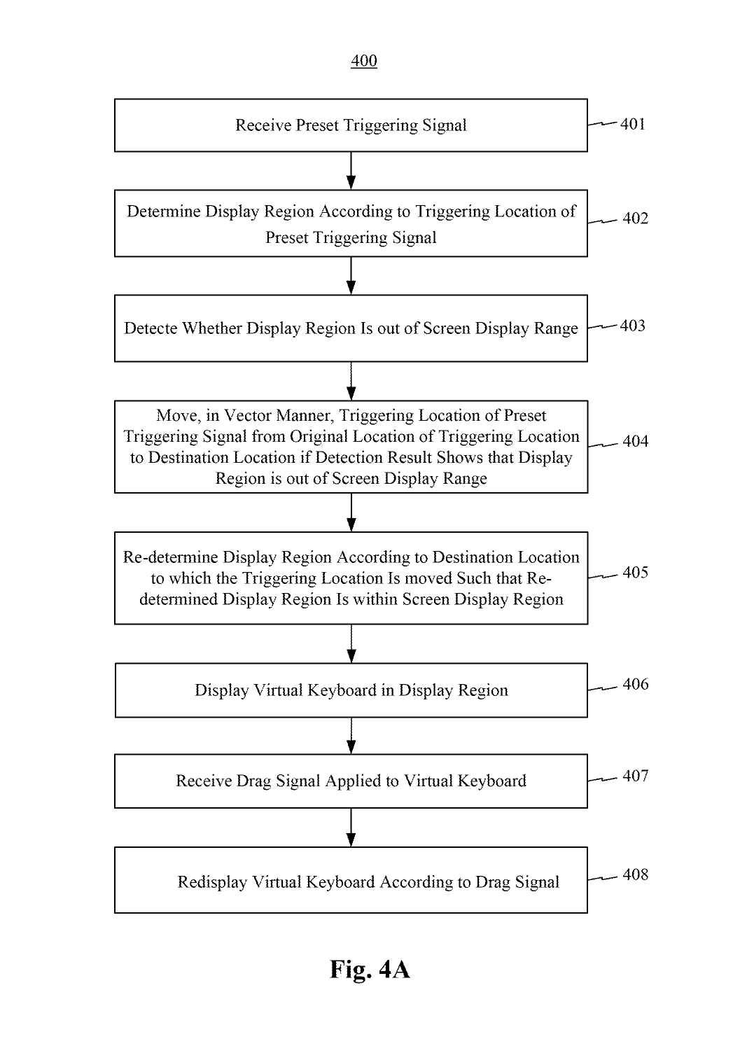

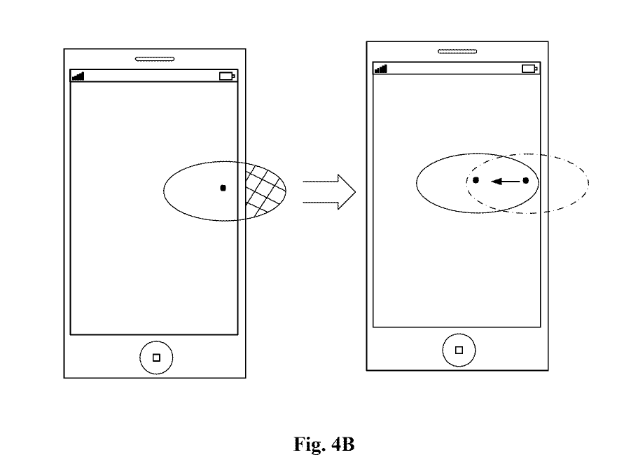

FIG. 4A is a flowchart of a method 400 for displaying a virtual keyboard on a terminal, according to another exemplary embodiment. The method 400 comprises the following steps. In step 401, the terminal receives a preset triggering signal triggered by a user. The triggering signal is used to trigger display of the virtual keyboard. The preset triggering signal may be triggered by clicking on an input box in an input interface with a finger, and may also be triggered by a long press on an unlock interface with a finger.

If the preset triggering signal is triggered by a click of a finger, a location where the finger clicks is a triggering location of the preset triggering signal. If the preset triggering signal is triggered by a long press of a finger, a location where the finger presses is the triggering location of the preset triggering signal. The preset triggering signal can be triggered by other methods, and is not limited by the above exemplary embodiment.

In step 402, the terminal determines a display region, according to the triggering location of the preset triggering signal. When the display region is a circular region, step 402 includes the following sub-steps: 1) when the display region is a circular region, a preset radius R is obtained for the circular region; and 2) the circular region is determined based on the triggering location of the preset triggering signal as the center of the circular region, and the preset radius R.

When the display region is an elliptic region, step 402 includes the following sub-steps: 1) when the display region is a elliptic region, a preset major axis R1 and a preset minor axis R2 are obtained; and 2) the elliptic region is determined based on the triggering location of the preset triggering signal as the center of the elliptic region, and the major axis R1 and the minor axis R2. The manners of determining the circular display region and the elliptic display region in step 402 are similar to those shown in FIG. 2A.

In step 403, the terminal detects whether the display region is out of a screen display range. Referring to FIG. 4B, for example, a part of the elliptic region (the shadowed region in FIG. 4B) is out of the screen display region. In step 404, if the detection result shows that the display region is out of the screen display range, the triggering location of the preset triggering signal is moved from the original location to a destination location, e.g., in a vector manner, to display the entire display region. The terminal first computes a horizontal distance and/or a vertical distance between 1) the original location of the triggering location of the preset triggering signal and 2) the destination location for displaying the entire display region, wherein the destination location is set as a center of the display region. The terminal then moves, in a vector manner, the triggering location of the preset triggering signal from the original location to the destination location, according to the computed horizontal distance and/or the vertical distance.

For example, assuming the original location of the triggering location of the preset triggering signal is (x, y). If the horizontal distance between the original location and the destination location is x1, the triggering location of the preset triggering signal is moved from the original location to the destination location of (x+x1, y) in a vector manner. If the vertical distance between the original location and the destination location is y1, the triggering location of the preset triggering signal is moved from the original location to the destination location of (x, y+y1) in a vector manner. If the horizontal distance and the vertical distance between the original location and the destination location are x2 and y2, respectively, the triggering location of the preset triggering signal is moved from the original location to a destination location of (x+x2, y+y2) in a vector manner.

In step 405, a display region is re-determined according to the destination location to which the triggering location is moved such that the re-determined display region is within the screen display region. Referring to FIG. 4B, for example, after the triggering location of the triggering signal is moved from the original location to the destination location in a vector manner, the re-determined display region is within the screen display region.

In step 406, the virtual keyboard is displayed in the re-determined display region. In this embodiment, the terminal displays the virtual keyboard in the re-determined display region in a preset arrangement including, but not limited to, the following exemplary arrangements: 1) buttons of the virtual keyboard are uniformly arranged in the display region in a ring pattern; and 2) buttons of the virtual keyboard are uniformly arranged in the display region in a tile pattern. It should be noted that if there are two display regions (e.g., a first display region and a second display region), and the virtual keyboard is displayed in the two display regions, a part of the virtual keyboard is displayed in the first display region in a preset manner, and the other part of the virtual keyboard is displayed in the second display region in the preset manner.

In step 407, the terminal receives a drag signal applied to the virtual keyboard. The user may apply the drag signal to the virtual keyboard to move the virtual keyboard to a desired location if the current/original location of the virtual does not meet user's needs. In step 408, the virtual keyboard is redisplayed according to the drag signal.

By using the method 400 for displaying a virtual keyboard in the above exemplary embodiment, the virtual keyboard can be displayed in the display region on the touchscreen determined by the triggering signal, and the fingers may directly touch the virtual keyboard in display region. The method 400 solves the problem of low input efficiency caused by users having to move fingers for operating virtual keyboards displayed and fixed in the lower portion of the touchscreens and by a limited finger movement range. The method 400 reduces back-and-forth finger movements and improves efficiency of information input. Additionally, the user may adjust the display location of the virtual keyboard at any time as needed by applying the drag signal to the virtual keyboard to redisplay the virtual keyboard according to the drag signal. It should be noted that, if the display region is out of the screen display region (e.g., when the triggering location of the preset triggering signal is too close to an edge of the screen) the triggering location of the preset triggering signal is moved from the current/original location to a destination location in a vector manner such that the re-determined display region is within the screen display region. The virtual keyboard is then displayed in the re-determined display region. Moreover, the terminal may be operated with one hand by the above method.

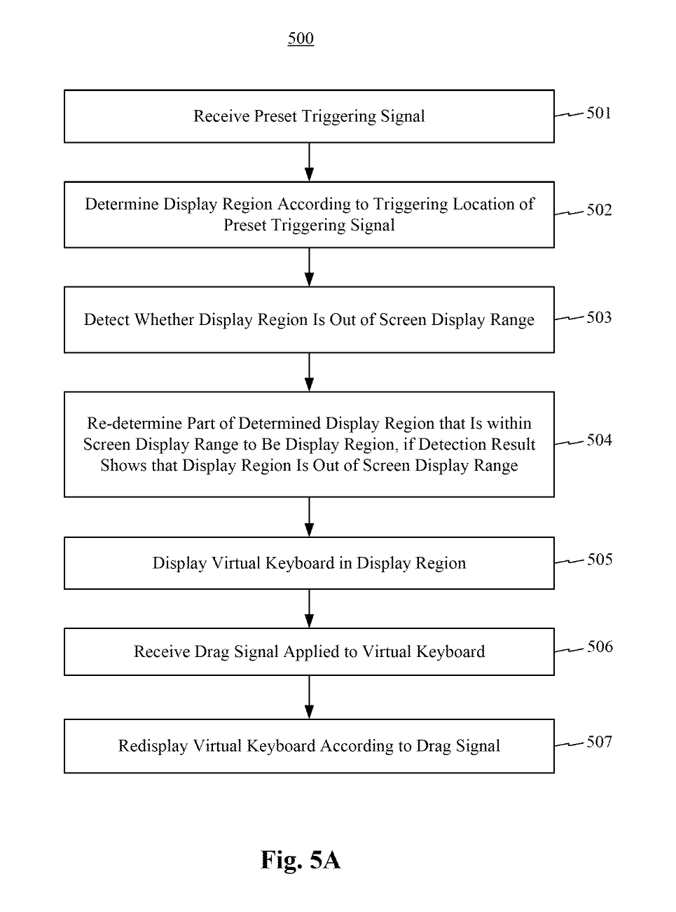

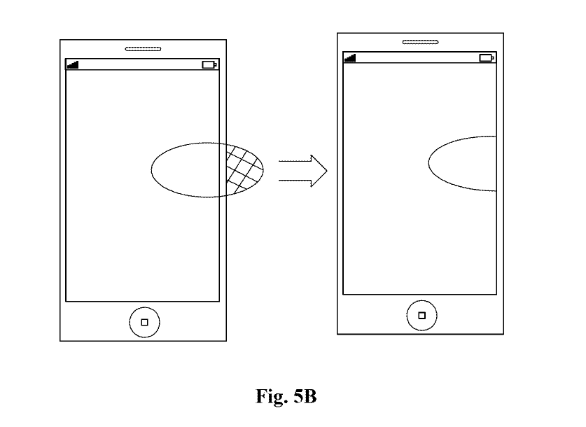

FIG. 5A is a flowchart of a method 500 for displaying a virtual keyboard on a terminal, according to another exemplary embodiment. The method 500 comprises the following steps. In step 501, the terminal receives a preset triggering signal triggered by a user. The triggering signal is used to trigger a display of the virtual keyboard. The triggering signal may be triggered by clicking on an input box in an input interface with a finger, and may also be triggered by a long press on an unlock interface with a finger.

If the preset triggering signal is triggered by a click of a finger, a location where the finger clicks is a triggering location of the preset triggering signal. If the preset triggering signal is triggered by the long press of a finger, a location where the finger presses is the triggering location of the preset triggering signal. The preset triggering signal can be triggered by other methods, and is not limited by the above exemplary embodiment.

In step 502, the terminal determines a display region, according to the triggering location of the preset triggering signal. When the display region is a circular region, step 502 includes the following sub-steps: 1) when the display region is a circular region, a preset radius R is obtained for the circular region; and 2) the circular region is determined based on the triggering location of the preset triggering signal as a center of the circular region, and the preset radius R. When the display is an elliptic region, step 502 includes the following sub-steps: 1) when the display is an elliptic region, a preset major axis R1 and a preset minor axis R2 are obtained; and 2) the elliptic region is determined based on the triggering location of the preset triggering signal as a center of the elliptic region, and the major axis R1 and the minor axis R2. The manners of determining the circular display region and the elliptic display region in step 502 are similar to those shown in FIG. 2A.

In step 503, the terminal detects whether the display region is out of a screen display range. Referring to FIG. 5B, for example, a part of the display region (shadowed region of FIG. 5B) is out of the screen display region. In step 504, if the detection result shows that a part of the display region is out of the screen display range, the other part of display region that is within the screen display region is re-determined to be the display region. That is, the part of the display region that is out of the screen display region is removed; and the part of the display region that is within the screen display region is re-determined as the display region. For example, as shown in FIG. 5B, the shadowed part of the elliptic display region, which represents the part of the display region that is out of the screen display region, is removed. The part of the elliptic display region that is within the screen display region is re-determined as a display region.

In step 505, the terminal displays the virtual keyboard in the re-determined display region. In this exemplary embodiment, the terminal displays the virtual keyboard in the re-determined display region in a preset manner including, but not limited to, the following two exemplary arrangements: 1) buttons of the virtual keyboard are uniformly arranged in the display region in a ring pattern; and 2) buttons of the virtual keyboard are uniformly arranged in the display region in a tile pattern. In this exemplary arrangement, buttons of the virtual keyboard are uniformly arranged in the tile pattern in the re-determined display region. In other words, the re-determined display region is filled with buttons of the virtual keyboard.

It should be noted that if there are multiple display regions (e.g., a first display region and a second display region), when the virtual keyboard is displayed in the two display regions, a part of the virtual keyboard is displayed in the first display region in a preset manner, and the other part of the virtual keyboard is displayed in the second display region in the preset manner,.

In step 506, the terminal receives a drag signal applied to the virtual keyboard. The user may apply the drag signal to the virtual keyboard to move the virtual keyboard to a desired location if the current/original location of the virtual does not meet the user's needs. In step 507, the terminal redisplays the virtual keyboard according to the drag signal.

By using the method 500 for displaying a virtual keyboard in the above exemplary embodiment, the virtual keyboard can be displayed in the display region on the touchscreen determined by the triggering signal, and the fingers may directly touch the virtual keyboard in display region. The method 500 solves the problem of low input efficiency caused by users having to move fingers for operating virtual keyboards displayed and fixed in the lower portion of the touchscreens and by a limited finger movement range. The method 500 reduces back-and-forth finger movements and improves efficiency of information input. Additionally, a user may adjust the display location of the virtual keyboard at any time by applying the drag signal to the virtual keyboard to redisplay the virtual keyboard according to the drag signal. It should be noted that, if the display region determined by the triggering location of the triggering signal is out of the screen display region, the part of the display region that is within the screen display region is re-determined to be the display region, and then the virtual keyboard is displayed in the re-determined display region. Moreover, the terminal may be operated with one hand by the above method.

The embodiments of the device in the present disclosure will be described as follows, and the embodiments that are not described in detail may be referred to the above corresponding embodiments.

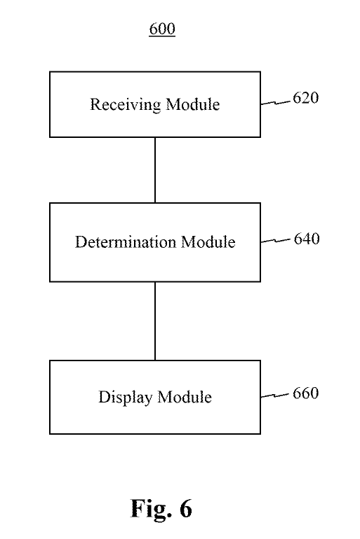

FIG. 6 is a block diagram illustrating a device 600 for displaying a virtual keyboard, according to an exemplary embodiment. The device 600 for displaying the virtual keyboard may be implemented by software, hardware or a combination thereof for forming a whole or a part of a terminal. The device 600 for displaying the virtual keyboard may include a receiving module 620, a determination module 640, and a display module 660.

The receiving module 620 is configured to receive a preset triggering signal for triggering a virtual keyboard. The determination module 640 is configured to determine a display region according to a triggering location of the preset triggering signal received by the first receiving module 620. The display module 660 is configured to display the virtual keyboard in the display region determined by the determination module 640.

By using the device 600 for displaying a virtual keyboard in the above exemplary embodiment, the virtual keyboard can be displayed in the display region on the touchscreen determined by the triggering signal, and the fingers may directly touch the virtual keyboard in display region. The device 600 solves the problem of low input efficiency caused by users having to move fingers for operating virtual keyboards displayed and fixed in the lower portion of the touchscreens and by a limited finger movement range. The device 600 reduces back-and-forth finger movements and improves efficiency of information input.

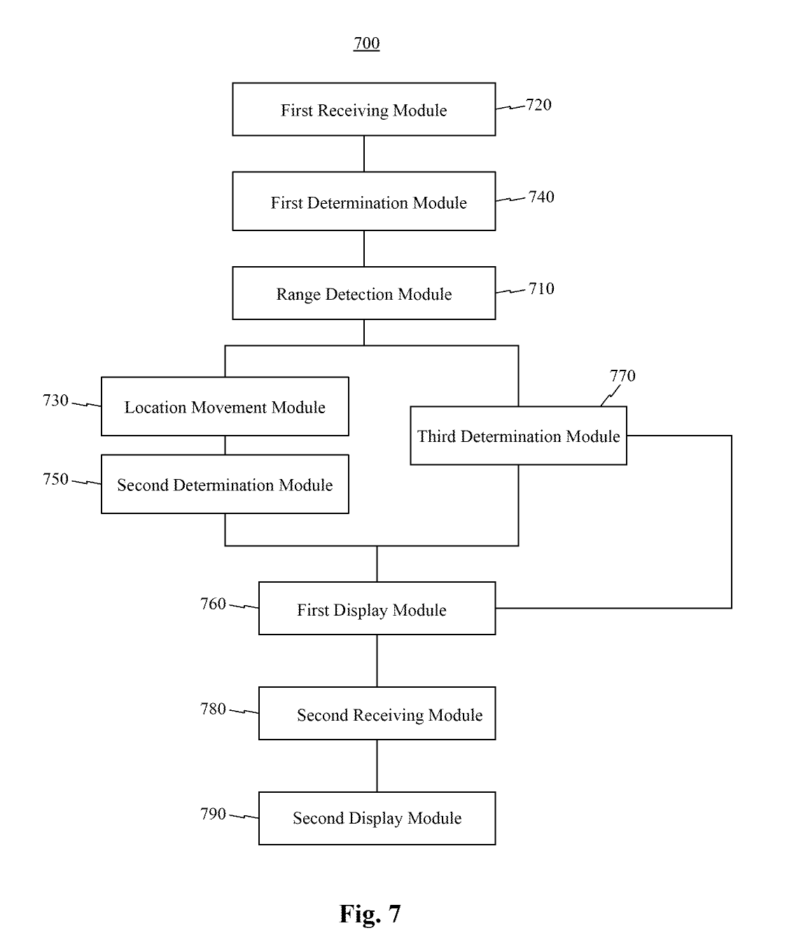

FIG. 7 is a block diagram of a device 700 for displaying a virtual keyboard, according to an exemplary embodiment. The device 700 for displaying a virtual keyboard may be implemented by software, hardware, or a combination thereof for forming a whole or a part of a terminal. The device 700 for displaying a virtual keyboard may include a first receiving module 720, a first determination module 740, and a first display module 760.

The first receiving module 720 is configured to receive a preset triggering signal for triggering a virtual keyboard. The first determination module 740 is configured to determine a display region according to a triggering location of the preset triggering signal received by the first receiving module 720. The first display module 760 is configured to display the virtual keyboard in the display region determined by the first determination module 740. The first determination module 740 may include a first determination unit and a second determination unit. The first determination unit is configured to obtain a preset radius R if the display region is a circular region. The first determination unit is also configured to determine the circular region based on the triggering location of the preset triggering signal as the center of the circular region, and the preset radius R. The second determination unit is configured to obtain a preset major axis R1 and a preset minor axis R2 if the display region is an elliptic region. The second determination unit is also configured to determine the elliptic region based on the triggering location of the preset triggering signal as the center of the elliptic region, and the major axis R1 and the minor axis R2.

The first display module 760 is configured to display the virtual keyboard in the display region in a preset arrangement including, but not limited to, the following exemplary arrangements: 1) buttons of the virtual keyboard are uniformly arranged in the display region in a ring pattern; and 2) buttons of the virtual keyboard are uniformly arranged in the display region in a tile pattern. If there are multiple display regions (e.g., a first display region and a second display region), the first display module 760 is configured to display a part of the virtual keyboard in the first display region in a preset manner, and to display the other part of the virtual keyboard in the second display region in the preset manner. The preset manner may include the following two arrangements: 1) buttons of the virtual keyboard are uniformly arranged in the display region in a ring pattern; and 2) buttons of the virtual keyboard are uniformly arranged in the display region in a tile pattern.

The device 700 for displaying a virtual keyboard may further include a range detection module 710, a location movement module 730, and a second determination module 750. The range detection module 710 is configured to detect whether the display region is out of a screen display range. The location movement module 730 is configured to move, in a vector manner, the triggering location of the preset triggering signal from an original location of the triggering location to a destination location, if the detection result shows that the display region is out of the screen display range. The second determination module 750 is configured to re-determine whether the display region at destination location is within the screen display region.

The device 700 for displaying a virtual keyboard may further include a third determination module 770. The third determination module 770 is configured to re-determine a part of the display region that is within the screen display region as the display region, if the detection result shows that the display region is out of the screen display range. The device 700 for displaying a virtual keyboard may further include a second receiving module 780 and a second display module 790. The second receiving module 780 is configured to receive a drag signal applied to the virtual keyboard. The second display module 790 is configured to redisplay the virtual keyboard according to the drag signal received by the second receiving module 780.

By using the device 700 for displaying a virtual keyboard in the above exemplary embodiment, the virtual keyboard can be displayed in the display region on the touchscreen determined by the triggering signal, and the fingers may directly touch the virtual keyboard in display region. The device 700 solves the problem of low input efficiency caused by users having to move fingers for operating virtual keyboards displayed and fixed in the lower portion of the touchscreens and by a limited finger movement range. The device 700 reduces back-and-forth finger movements and improves efficiency of information input. Additionally, a user may adjust the display location of the virtual keyboard at any time as needed by applying the drag signal to the virtual keyboard to redisplay the virtual keyboard according to the drag signal. When the user horizontally holds the device with hands, the user may operate two parts of the virtual keyboard simultaneously displayed on left and right sides of the device to improve the speed of information input. Further, if the display region is detected to be out of the screen display region, the triggering location of the preset triggering signal is moved from an original location of the triggering location to a destination location in a vector manner. A display region is then re-determined according to the destination location such that the re-determined display region is within the screen display region. The virtual keyboard is then displayed in the re-determined display region. Alternatively and additionally, if the display region is detected to be out of the screen display region, the part of the display region in the screen display region is re-determined as the display region. The virtual keyboard is then displayed in the re-determined display region.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

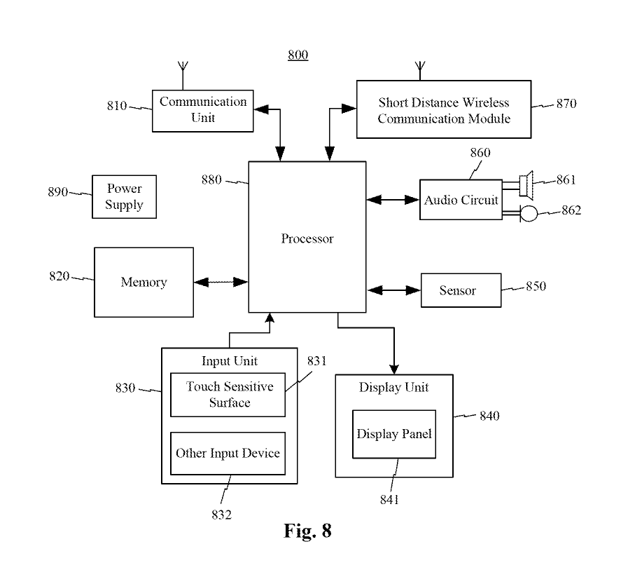

FIG. 8 is a block diagram illustrating a terminal 800 according to an exemplary embodiment of the present disclosure. The terminal 800 may be any of the terminals described in the above embodiments. The terminal 800 may include one or more of the following components: a communication unit 810, a memory 820 including one or more computer readable storage media, an input unit 830, a display unit 840, a sensor 850, an audio circuit 860, a short distance wireless communication module 870, a processor 880 including one or more process cores, and a power source 890 and the like. Those skilled of the art may understand that the structure of the terminal 800 is not restrictive to the illustrated components as shown in FIG. 8, and it may comprise more or less components than those illustrated in FIG. 8, or may comprise a combination of some components, or different component arrangements.

The communication unit 810 is configured to transmit or receive information during the transmission and reception of information or during a process of calling. Particularly, the downlink information from the base station is received and then is transmitted to the one or more processor 880 to be processed. In addition, the communication unit 810 transmits uplink data to the base station. In general, the communication unit 810 includes, but not limited to, an antenna, at least one amplifier, a tuner, one or more oscillator, a SIM card, a transceiver, a coupler, a Low Noise Amplifier (LNA), a duplexer, and the like. The communication unit 810 may be communicated with other device via wireless communication and a network. The communication unit 810 may adopt any one communication standard or protocol including, but not limited to, Global System of Mobile communication (GSM), General Packet Radio Service (GPRS), Code Division Multiple Access (CDMA), Wideband Code Division Multiple Access (WCDMA), Long Term Evolution (LTE), email, Short Messaging Service (SMS), and, the like.

The memory 820 is configured to store software programs and modules. For example, the memory 820 is configured to store a program for collecting voice signals, a program for identifying key words, a program for realizing continuous speech recognition, a program for setting a reminder, and the like. The processor 880 may perform various functions and data processing by operating programs and modules stored in the memory 820, for example, a function of “receiving a preset triggering signal,” a function of “determining a display region according to an triggering location of the triggering signal,” a function of “displaying a virtual keyboard on the display,” and, the like. The memory 820 may mainly include a program storage area and a data storage area. The program storage area may store an operation system, applications required by at least one required functions (such as voice play function, image play function and the like), and the data storage area may store data (such as video data, phonebook data, and the like) created by the use of the terminal 800. In addition, the memory 820 may include a high speed random access memory, or further include a non-volatile memory, such as at least a magnetic disk storage device, a flash memory, or other volatile solid-state storage device. Accordingly, the memory 820 may further comprise a memory controller to provide accesses from the processor 820 and the input unit 830 to the memory 820.

The input unit 830 is configured to receive inputs of numerical information or character information, and to generate signal inputs through a keypad, a keypad, a mouse, an operation rod, optical or trackball related to user settings, and function control. Optionally, the input unit 830 may include a touch-sensitive surface 831 and other input device 832. The touch-sensitive surface 831, also known as a touch screen or a touch pad, may collect touch action performed by the user on or in proximity of the touch-sensitive surface 831 (using any suitable object such as a finger or a touch pen), and connect corresponding devices according to a preset program. Alternatively, the touch-sensitive surface 831 may include two parts, i.e., a touch detecting device and a touch controller. The touch detecting device detects a location touched by the user and a signal generated from the touch action, and transmits the signal to the touch controller. The touch controller receives touch information from the touch detecting device and converts it into the touch point coordinates, and then transmits the coordinates to the processor 880. The touch controller also receives and performs instructions from the processor 880. Additionally, the touch-sensitive surface 831 may be realized using various types of touch-sensitive surface, such as a resistive touch-sensitive surface, a capacitive touch-sensitive surface, an infrared touch-sensitive surface, a surface acoustic wave touch-sensitive surface, and the like. In addition to the touch-sensitive surface 831, the input unit 830 may further include other input device 832. Optionally, the other input device 832 may include, but not limited to, one or more of a physical keyboard, function buttons (such as a volume control button, a switch button and the like), a trackball, a mouse, and a joystick.

The display unit 840 is configured to display various kinds of graphic user interfaces of information input by the user or provided to the user or the terminal 800. These graphic user interfaces may be made up of graphics, texts, icons, videos and any other combination thereof. The display unit 840 may include a display panel 841 based on LCD (Liquid Crystal Display), OLED (Organic Light-Emitting Diode) or the like. Furthermore, the touch sensitive surface 831 may be configured to cover the display panel 841. When the touch operation performed on or in proximity of the touch sensitive surface 831 is detected, the touch sensitive surface 831 may transmit signals to the processor 880 for determining the type of the touch event. The processor 880 may then provide a corresponding visual output on the display panel 841 according to the type of touch event. In FIG. 8, although the touch sensitive surface 831 and the display panel 841 are served as two independent components for realizing the input and output functions, they can be integrated together in some embodiments to realize the input and output functions.

The terminal 800 may further include at least one sensor 850 such as a photo sensor, a movement sensor, and other sensors. For example, the photo sensor may include an ambient light sensor and a proximity sensor. The ambient light sensor may adjust brightness of the display panel 841 according to intensity of the ambient light. The proximity sensor may close the display panel and/or backlight when the terminal 800 is close to the user's ear. Movement sensors including, for example, a gravitational acceleration sensor may detect values of accelerations in various directions (usually three axes), and may detect a value and a direction of the gravitation when resting, and may be used in an application for identifying orientation/position of a mobile phone (such as switching between a landscape mode and a vertical mode, gaming applications, and calibration of a magnetometer), and for detecting vibration (applications such as a pedometer and detection of impacts) and the like. Other sensors such as a gyroscope, a barometer, a humid meter, a thermometer, an infrared sensor, and the like may also be arranged in the terminal 800.

The audio circuit 860 is coupled to a speaker 861 and a microphone 862, and may provide an audio interface between the user and the terminal 800. The audio circuit 860 may convert the received audio data into electronic signals and transmit the electronic signals to the speaker 861, and the speaker 861 may convert the electronic signals into voice and output the voice. Additionally, the microphone 862 may convert the collected voice signals into electronic signals. The audio circuit 860 receives the electronic signals and converts them into audio data; and the audio data is transmitted to the processor 880. The audio data is then transmitted to another terminal device via the communication unit 810 after processed by the processor 880. Alternatively, the audio data is transmitted to the memory 820 to be further processed. The audio circuit 860 may further include an earplug jack to allow communication between a peripheral earphone and the terminal 800.

The short distance wireless communication 870 may be a Wireless Fidelity (WiFi) module or a Bluetooth module. The terminal 800 may help the user transmit or receive E-mail, browse web pages and access streaming media and the like through the short distance wireless communication unit 870, which provides the user the wireless broadband internet access. Although the short distance wireless communication unit 870 is shown in the drawings, it should be understood that the short distance wireless communication unit 870 is not a necessary component for the terminal 800, and may be omitted without changing the substance of the present disclosure.

The processor 880 is a control center of the terminal 800, and uses various interfaces and wires to connect respective portions of the whole client computer. By running or executing software programs and/or modules stored in the memory 820, calling data stored in the memory 820, and executing various functions of the terminal 800 and processing data, the processor 880 monitors the terminal 800. Additionally, the processor 880 may include one or more processing cores. Further, the processor 880 may integrate application processors and modem processors, wherein the application processors may process the operation systems, the user interfaces, the application programs, and the like. The modem processors may process wireless communications. It should be noted that the above modem may not be integrated into the processor 880.

The terminal 800 may further include the power supply 890 configured to supply power to respective components of the terminal 800. Optionally, the power supply 890 may be logically connected with the processor 880 through a power supply management system, thereby realizing functions of managing charging, discharging, power consumption, and the like of the power supply 890, through the power supply management system. The power supply 890 may further include arbitrary components such as one or more DC or AC power supplies, a rechargeable system, a power supply malfunction detection circuit, a power supply converter or an inverter, a power supply state indicator, and the like.

Although not shown in FIG. 8, the terminal 800 may further include a camera.

In exemplary embodiments, there is also provided a non-transitory computer readable storage medium including instructions, such as included in the memory 820, executable by the processor 880 in the terminal 800, for performing the above-described methods for displaying a virtue key board. For example, the storage medium may be a read-only memory (ROM), a magnetic disc, an optical disc, etc.

A person skilled in the art should appreciate that a part or all of steps described in the above embodiments may be realized through hardware, or through a hardware instructed by a program stored in a computer readable storage medium. The storage medium may be a ROM, a magnetic disk or a disk.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for displaying a virtual keyboard, comprising:
receiving a preset triggering signal for triggering display of the virtual keyboard;
determining a display region according to a triggering location of the preset triggering signal; and
displaying the virtual keyboard in the display region.

2. The method according to claim 1, wherein when the display region is a circular region, the determining of the display region comprises:
obtaining a preset radius R; and
determining the circular region based on the triggering location of the preset triggering signal as a center of the circular region, and the preset radius R.

3. The method according to claim 1, wherein when the display region is an elliptic region, the determining of the display region comprises:
obtaining a preset major axis R1 and a preset minor axis R2; and
determining the elliptic region based on the triggering location of the preset triggering signal as a center of the elliptic region, and the major axis R1 and the minor axis R2.

4. The method according to claim 1, wherein the displaying of the virtual keyboard in the display region comprises:
uniformly arranging buttons of the virtual keyboard in the display region in a ring pattern.

5. The method according to claim 1, wherein the displaying of the virtual keyboard in the display region comprises:
uniformly arranging buttons of the virtual keyboard in the display region in a tile pattern.

6. The method according to claim 1, wherein when determining a display region includes determining a first display region and a second display region, the method further comprises:
displaying a part of the virtual keyboard in the first display region in a preset manner and the other part of the virtual keyboard in the second display region in the preset manner, wherein the preset manner comprises at least one of:
uniformly arranging buttons of the virtual keyboard in at least one of the first and second display regions in a ring pattern; or uniformly arranging buttons of the virtual keyboard in at least one of the first and second display regions in a tile pattern.

7. The method according to claim 1, further comprising:
detecting whether the display region is out of a screen display range;
moving the triggering location of the preset triggering signal to a destination location if the detection result indicates that the display region is out of the screen display range; and
re-determining the display region according to the destination location such that the re-determined display region is within the screen display range.

8. The method according to claim 1, further comprising:
detecting whether the display region is out of a screen display range; and
re-determining a part of the display region within the screen display range as a re-determined display region if the detection result indicates that the display region is out of the screen display range.

9. The method according to claim 1, further comprising:
receiving a drag signal applied to the virtual keyboard; and
redisplaying the virtual keyboard according to the drag signal.

10. A device for displaying a virtual keyboard, comprising:
a processor; and
a memory for storing instructions executable by the processor;
wherein the processor is configured to:
receive a preset triggering signal for triggering display of the virtual keyboard;
determine a display region according to a triggering location of the preset triggering signal; and
display the virtual keyboard in the display region.

11. The device according to claim 10, wherein when the display region is a circular region, the processor is further configured to:
obtain a preset radius R; and
determine the circular region based on the triggering location of the preset triggering signal as a center of the circular region, and the preset radius R.

12. The device according to claim 10, wherein when the display region is an elliptic region, the processor is further configured to:
obtain a preset major axis R1 and a preset minor axis R2; and
determine the elliptic region based on the triggering location of the preset triggering signal as a center of the elliptic region, and the major axis R1 and the minor axis R2.

13. The device according to claim 10, wherein the processor is further configured to:
uniformly arrange buttons of the virtual keyboard in the display region in a ring pattern.

14. The device according to claim 10, wherein the processor is further configured to:
uniformly arranging buttons of the virtual keyboard in the display region in a tile pattern.

15. The device according to claim 10, wherein when the processor determines a first display region and a second display region, the processor is further configured to:
display a part of the virtual keyboard in the first display region in a preset manner and the other part of the virtual keyboard in the second display region in the preset manner, wherein the preset manner comprises at least one of:
uniformly arranging buttons of the virtual keyboard in at least one of the first and second display regions in a ring pattern; or uniformly arranging buttons of the virtual keyboard in at least one of the first and second display regions in a tile pattern.

16. The device according to claim 10, wherein the processor is further configured to:
detect whether the display region is out of a screen display range;
move the triggering location of the preset triggering signal to a destination location if the detection result indicates that the display region is out of the screen display range; and
re-determine the display region according to the destination location such that the re-determined display region is within the screen display range.

17. The device according to claim 10, wherein the processor is further configured to:
detect whether the display region is out of a screen display range; and
re-determine a part of the display region within the screen display range as a re-determined display region if the detection result indicates that the display region is out of the screen display range.

18. The device according to claim 10, wherein the processor is further configured to:
receive a drag signal applied to the virtual keyboard; and
redisplay the virtual keyboard according to the drag signal.

19. A non-transitory computer-readable medium that stores a set of instructions which, when executed by a processor, performs a method for displaying a virtual keyboard, the method comprising:
receiving a preset triggering signal for triggering display of the virtual keyboard;
determining a display region according to a triggering location of the preset triggering signal; and
displaying the virtual keyboard in the display region.
